(19) United States
(12) Patent Application Publication
(10) Pub. No.: US 2006/0003096 A1
(43) Pub. Date: Jan. 5, 2006

(54) Apparatus and method for applying adhesive to a substrate

(75) Inventors: Dominik Hartmann, Baar (CH); Stephan Scholze, Zurich (CH)

Correspondence Address: David B. Ritchie;Thelen Reid & Priest LLP, P.O. Box 640640, San Jose, CA, 95164-0640, US

(73) Assignee: Unaxis International Trading Ltd

(21) Appl. No.: 11/173,327

(22) Filed: Jun. 30, 2005

(30) Foreign Application Priority Data
Jun. 30, 2004 (EP) 04103089.1

(51) Int. Cl. B05D 5/10; B29C 65/00

(52) U.S. Cl. 427/207.1; 156/349

(57) ABSTRACT

An apparatus for applying adhesive to a substrate (2) comprises a writing head (4) with a writing nozzle (5) and a camera (11). The writing head (4) can be moved in two horizontal directions so that it can write an adhesive pattern on the substrate (2). The position of the writing head (4) designated as the z height is controlled very accurately by means of a position measuring and control circuit (6) so that the tip of the writing nozzle (5) can be guided at a predetermined distance Δz₀ above the substrate (2). In accordance with the invention, the apparatus is equipped with a triangulation measuring system with the aid of which the z height of the substrate (2) is determined and with a calibration device (15) for determining the relationship between the z position of the writing head (4) and the z height of the substrate (2).

### PRIORITY CLAIM

The present application claims priority under 35 U.S.C § 119 based upon European Patent Application No. 04103089.1 filed on Jun. 30, 2004.

### FIELD OF THE INVENTION

The invention concerns an apparatus and a method for applying adhesive to a substrate.

### BACKGROUND OF THE INVENTION

With the mounting of semiconductor chips, epoxy based adhesives are often used in order to attach the semiconductor chip to a substrate. The adhesive has to be applied to the substrate so that, on subsequent placement of the semiconductor chip, an adhesive layer free of air voids occurs distributed as uniformly as possible over the entire surfathrough ce of the chip. Ideally, the adhesive layer extends laterally beyond the edges of the semiconductor chip and also completely embraces the corners of the semiconductor chip. Furthermore, no adhesive must get onto the surface of the semiconductor chip with the electronic circuits. In order to achieve this, depending on the chip format, type of adhesive and other parameters, different “figured” application patterns are used that range from a simple diagonal cross up to multiple branched line patterns.

Basically, two methods are known in order to apply such figured patterns. With the first method, known for example from the European patent application EP 928 637, application is done by means of a dispensing nozzle formed with numerous outlets. The outlets of the nozzle are located at a predetermined height above the substrate. The necessary amount of adhesive is ejected by means of a pressure pulse. In doing so, the shape of the ejected amount of adhesive is dependent on the distance between the nozzle and the substrate. With the second method known for example from U.S. Pat. No. 6,129,040, application is done by means of a single nozzle secured to a writing head. The writing head is guided over the substrate with a programmed movement corresponding to the desired adhesive pattern and, in doing so, “draws” the adhesive pattern.

The application of the adhesive to the substrate is a tricky process. An important parameter that has to be observed with the greatest accuracy is the distance of the nozzle from the substrate. Before the production process starts, the height of the substrate places has to be measured. This is done in that the height adjustable nozzle is lowered until it touches the substrate place. This contact is detected and saved as the substrate height. This measuring method has several disadvantages:

The nozzle often leaves adhesive on the substrate.

The measurement is slow because the contact is detected mechanically.

For applications with which several semiconductor chips are mounted on top of each other (so-called “stacked die” applications), the height of the surface of each semiconductor chip has to be determined onto which the next semiconductor chip is to be placed. Here there is a great risk that the semiconductor chip is damaged during measurement.

### BRIEF DESCRIPTION OF THE INVENTION

The object of the invention is to develop a measuring method that no longer has these named disadvantages.

An apparatus for applying adhesive to a substrate comprises a writing head with a writing nozzle and a camera. The writing head is movable in two horizontal directions x and y and is moved along a predetermined path in the plane spanned by the coordinates x and y in order to write an adhesive pattern on the substrate. The position of the writing head designated as the z height is controlled very accurately by means of a position measuring and control circuit in order that the tip of the writing nozzle can be guided at a predetermined distance Δz₀ above the substrate. In order that the adhesive pattern is applied at the correct position on the substrate, before applying the adhesive, a camera measures the position of the substrate. In accordance with the invention, the apparatus is equipped with a triangulation measuring system with the aid of which the actual z height of the substrate can be determined in relation to a reference height H_{R} and with means for determining the z position of the writing head in relation to the reference height H_{R}. The triangulation measuring system comprises a laser that emits a laser beam that includes a predetermined angle with the horizontal and uses the camera that is present in any case for determining the position of the point of impingement of the laser beam on the substrate. During a calibration process, the point of impingement of the laser beam on a reference surface is determined and from it the z height of the reference surface calculated, and the z position of the writing head at which the writing nozzle of the writing head touches the reference surface is determined. In production, the position of the point of impingement of the laser beam on the substrate is determined and from it the z height of the substrate is calculated and then the z position of the writing head adjusted according to the measured z height of the substrate such that the tip of the writing nozzle is moved at a predetermined distance Δz₀ above the substrate.

The application of adhesive to the substrate according to the invention consists of a calibration process with which the z position of the writing head in relation to the reference height H_{R} is found out by determining the z height of the reference surface in relation to the reference height H_{R} by means of the triangulation measuring system and by determining the z position of the writing head at which the writing nozzle touches the reference surface and of the production process of applying adhesive to the substrate with which first the z height of the substrate in relation to the reference height H_{R} as a constant value H₁ or the z height H₁(x, y) as a function of the two horizontal directions x and y by means of the triangulation measuring system is determined and with which then the z position of the writing head during the movement of the writing head along the predetermined path for the application of adhesive is controlled to a z height z=H₁+Δz₀ or z(x, y)=H₁(x, y)+Δz₀, respectively, whereby the parameter Δz₀ has a predetermined value.

The calibration of the z position of the writing head in relation to the reference height H_{R} occurs by means of a calibration device. The calibration device comprises a reference surface the z height of which is determined in a first step by means of the triangulation measuring system. In a second step the z position of the writing head is determined at which the writing nozzle touches the reference surface.

In a first embodiment the reference surface of the calibration device is deflectable in z direction. The laser and the camera are positioned in relation to the calibration device such that the laser beam falls on the reference surface and that the point of impingement is located within the field of view of the camera. Then the writing head is lowered in z direction until the writing nozzle touches and deflects the reference surface. As soon as the writing nozzle deflects the reference surface the position of the point of impingement of the laser beam shifts. The begin of the shift of the point of impingement is detected by the camera and from the position data of the position measuring and control circuit the z position of the writing head is determined at that moment in time at which the writing nozzle touched the reference surface.

In a second embodiment the calibration device comprises a light source that illuminates the writing nozzle from the side and obliquely so that the shadow of the writing nozzle falls on the reference surface of the calibration device. During lowering of the writing head the shadow of the writing nozzle moves. As soon as the tip of the writing nozzle touches the reference surface an end of the shadow and the tip of the writing nozzle coincide. The movement of the shadow is monitored with the camera and from it as well as from the position data of the position measuring and control circuit the z position of the writing head is determined at which the writing nozzle touches or would touch the reference surface. If the angle is known under which the light emitted from the light source falls on the reference surface then it is possible to determine the z position of the writing head at which the writing nozzle would touch the reference surface without that the writing head is lowered until the writing nozzle effectively touches the reference surface. Preferably the writing nozzle is provided with an appendage and then the movement of the shadow of the appendage analyzed.

During production the application of the adhesive is carried out in that the position of the point of impingement of the laser beam on the substrate is determined and the z height H₁ of the substrate is calculated. The z height of the substrate can be measured for example at a single location. During application of the adhesive the writing head then takes the z position z=H₁+Δz₀ wherein the parameter Δz₀ has a predetermined value. The parameter Δz₀ amounts typically to 10 micrometers. Alternatively the z height of the chip mounting area of the substrate can be measured at least at three locations and therefrom the z height H₁(x, y) calculated as a function of the two horizontal coordinate axes x and y and the writing head guided at the z position z(x, y)=H₁(x, y)+Δz₀ when applying the adhesive.

The writing head performs movements in x- and in y- direction. Because of unavoidable mechanical tolerances the distance between the writing head and the process plate on which the substrate is positioned changes therefore. Therefore it is preferable to determine a correction function by means of a further calibration process that describes the variation of the z position of the writing head in function of the coordinates u₁ to uₙ, wherein the coordinates u₁ to uₙ correspond to the entirety of the degrees of freedom of the writing head and therefore characterize the position of the writing head. The writing head then occupies the z position z′(x, y)=z(x, y)+Δz(u₁, u₂, . . . uₙ) when applying the adhesive. Naturally one of the coordinates u₁ to uₙ equals the coordinate x and another of the coordinates u₁ to uₙ equals the coordinate y. Therefore the coordinates u₁ to uₙ can alternatively be represented by (x, y, {u}) wherein {u} designates the additional coordinates that characterize the position of the writing head. If the number of degrees of freedom of the writing head in horizontal directions is 2 then {u}={0} (mathematically called an empty set), because the coordinates x and y suffice to describe the position of the writing head. The writing head then occupies the z position z′(x, y)=z(x, y)+Δz(x, y, {u}) when applying the adhesive.

### BRIEF DESCRIPTION OF THE DRAWING FIGURES

The accompanying drawings, which are incorporated into and constitute a part of this specification, illustrate one or more embodiments of the present invention and, together with the detailed description, serve to explain the principles and implementations of the invention. The figures are not to scale. In the drawings:

FIG. 1 shows an apparatus for applying adhesive to a substrate,

FIG. 2 shows a presentation of geometrical relationships,

FIG. 3 shows a shuttle onto which a camera and a laser are secured,

FIG. 4 shows a drive system for a writing head,

FIG. 5 shows a calibration device, and

FIG. 6 shows another calibration device.

### DETAILED DESCRIPTION OF ;HE INVENTION

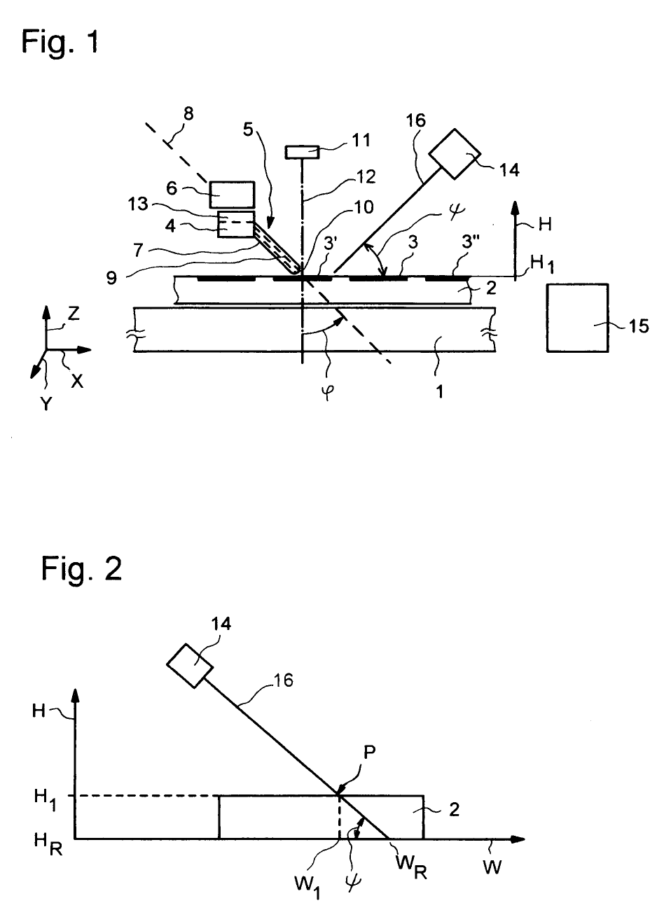

FIG. 1 shows a side view of an apparatus for applying adhesive to a substrate 2 that is used as a dispensing station on a semiconductor mounting apparatus known as a Die Bonder. The axes of a Cartesian system of coordinates are designated with x, y and z whereby the two axes x and y run in a horizontal plane. In addition, the x-axis designates the transport direction of a transport device 1 for transporting the substrates 2. Each substrate 2 has a predetermined number of chip mounting sites 3, 3′ that are arranged at regular intervals. Optionally, the transport device 1 enables a shifting of the substrate 2 along the y-axis. The transport device 1 first transports the substrate 2 in the transport direction x to the dispensing station where adhesive is applied to the presented chip mounting site 3′ and then to a bonding station where a semiconductor chip is placed onto the chip mounting site. Such a transport device 1 is known for example from U.S. Pat. No. 5,163,222. The dispensing station comprises a writing head 4 with a writing nozzle 5. A drive system enables movement of the writing head 4 in the three directions x, y and z. A suitable drive system that also has a position measuring and control circuit 6 for the precise control of the z height of the writing head 4 is known for example from U.S. Pat. No. 6,129,040. Preferably, the writing nozzle 5 is mounted detachably on the writing head 4. The writing nozzle 5 has a longitudinal shape: it consists of a longitudinal body 7 with a drill hole 9 running along the longitudinal axis 8 of the body 7 that at the tip opens out in a single outlet 10. The semiconductor mounting apparatus also comprises a camera 11 for measuring the position and orientation of the chip mounting site 3′ presented for the application of adhesive. The optical axis 12 of the camera 11 runs parallel to the z-axis. The optical axis 12 of the camera 11 therefore runs perpendicularly to the chip mounting site 3′. With correct focussing of the camera 11, the entire chip mounting site 3′ lies in the plane of sharpness of the camera 11. The writing nozzle 5 is arranged on the writing head 4 so that its longitudinal axis 8 describes a predetermined angle φ with the z-axis or the optical axis 12 of the camera 11. The angle φ lies typically in the range of 30° to 60°. In this way, only the tip of the writing nozzle 5 is located in the area of the optical axis 12 of the camera 11. Part of the writing nozzle 5 is still located in the field of view of the camera 11. The length of the writing nozzle 5 is dimensioned so that the writing head 4 is located outside the field of view of the camera 11 or at most covers an edge area of the field of view of the camera 11 or of the image delivered by the camera 11. The writing nozzle 5 is connected to an adhesive reservoir and a pump 13 controls the discharge of adhesive from the writing nozzle 5. The pump 13 can be integrated into the writing head 5 as in the example shown or arranged stationary on the semiconductor mounting apparatus.

In accordance with the invention, the dispensing station is equipped with a triangulation measuring system with a laser 14 and with a calibration device 15 for the determination of the z position of the writing head 4 in relation to a reference height H_{R}. As can be seen in FIG. 2, the laser 14 emits a laser beam 16 directed towards the substrate 2 that impinges obliquely on the substrate 2 at a predetermined angle ψ in relation to the horizontal. The angle ψ lies preferably in the range of 30° to 60°. Typically, it amounts to around 45°. When the height H₁ of the surface of the substrate 2 changes, then the position of the point of impingement P of the laser beam 16 on the substrate 2 also changes. The position of the point of impingement P is determined with the camera 11 and the height H₁ of the surface of the substrate 2 is calculated from the position change Δw. The height H₁ of the surface of the substrate 2 results in:
H₁=H_{R}+Δw*tan(ψ) (1)
Thereby designate:
w: a coordinate axis that is defined as the direction of the laser beam 16 in the xy plane, ie, the projection of the laser beam 16 on the xy plane,
w_{R}: the position of the point of impingement P of the laser beam 16 when the point of impingement P is located at the reference height H_{R},
w₁: the position of the point of impingement P of the laser beam 16 when the surface of the substrate 2 is located at the height H₁ to be measured, and
Δw=w₁−w_{R}.

From the image delivered by the camera 11 one gets the positions p_{R} and p₁ in pixel coordinates. By means of a calibration measurement therefore, a conversion factor k has to be determined so that the difference Δp=p₁−p_{R} calculated in pixel coordinates of the camera 11 can be converted into the absolute travel difference Δw:
Δw=k*Δp. (2)
and one gets
H₁=H_{R}+k*Δp*tan(ψ) (3)

When the camera 11 as well as the laser 14 are arranged stationary, then the position of the point of impingement P is only dependent on the height H₁ to be measured and the height H₁ can be calculated with the pixel coordinates delivered by the camera 11 according to the equation (3). In many cases however it is inevitable that the laser 14 and/or the camera 11 are moveable in x and/or y direction. In these cases, it is advantageous to use a global system of coordinates (u, v) and to always convert the regulated positions of the laser 14 and the camera 11 as well as the measured positions w₁ and w_{R} of the point of impingement P of the laser beam 16 into global coordinates (u₁, v₁) or (u_{R}, v_{R}), respectively, and to calculate the height H₁ from these.

In the following, preferred possibilities are explained as to how the laser 14 is to be integrated into the dispensing station.

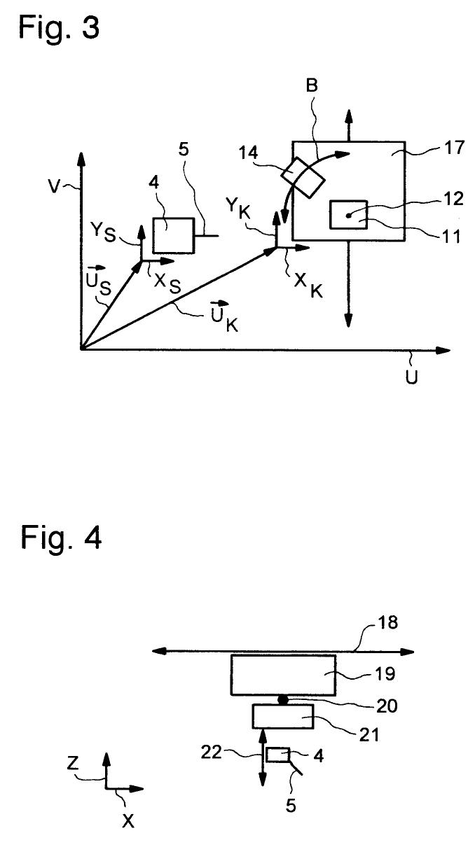

For a dispensing station with which the camera 11 is moveable in y direction, the laser 14 is preferably arranged so that it is moveable in y direction together with the camera 11. FIG. 3 shows a plan view of such an example. The camera 11 and the laser 14 are arranged on a shuttle 17 that is moveable in the y direction. Preferably, the position of the laser 14 on the shuttle 17 is adjustable within a predetermined range B so that, if necessary, the direction w can be altered. In addition, with this example a first local system of coordinates (xₛ, yₛ) of the writing head 4, a second local system of coordinates (x_{K}, y_{K}) of the camera 11 and the global system of coordinates (u, v) are presented. A position measuring and control system of the writing head 4 controls the position of the writing head 4 in relation to the local coordinates (x_{S}, y_{S}), a position measuring and control system of the camera 11 controls the position of the optical axis 12 of the camera 11 in relation to the local coordinates (x_{K}, y_{K}). The global coordinates of the writing head 4 are given by
(u_{S}, v_{S})=(u_{S0}, v_{S0})+(x_{S}, y_{S}),
the global coordinates of the optical axis 12 of the camera 11 are given by
(u_{K}, v_{K})=(u_{K0}, v_{K0})+(x_{K}, y_{K}).

FIG. 4 shows a drive system for the movement of the writing head 4 along the three coordinate axes x, y and z. The drive system comprises a first, rigidly arranged guide 18 on which a first shuttle 19 moveable in x direction bears, a second guide 20 arranged on the first shuttle 19 on which a second shuttle 21 moveable in y direction bears, and a third guide 22 arranged on the second shuttle 21 on which the writing head 4 bears, as well as three motors for driving the first shuttle 19 in x direction, driving the second shuttle 21 in y direction and driving the writing head 4 in z direction.

If the laser 14 is not arranged rigidly nor arranged moveably together with the camera 11, then a first possibility exists in securing the laser 14 on the writing head 4 so that the laser 14 follows all movements of the writing head 4 in x, y and z direction. A second possibility exists in securing the laser 14 to the second shuttle 21 so that the laser 14 only follows the movements of the writing head 4 in x and y direction but not in z direction. A further possibility exists in combining the solutions shown in FIGS. 3 and 4, i.e. not to arrange the guide 18 shown in FIG. 3 stationary but to secure it to the shuttle 17 shown in FIG. 3 and to mount the laser 14 on the slide 21. With this solution the writing head 4 is movable in the global direction v together with the camera 11 as well as relatively to the camera 11.

With all these three design possibilities, the laser 14 is preferably secured so that it can be rotated on the axis of the laser beam 16 so that the polarisation direction of the laser light can be changed in relation to the substrate 2 and that the direction w is adjustable so that any diffraction effects of the laser light on the substrate 2 can be minimised. Especially with semiconductor chips that have storage elements with numerous structures running parallel to the edges of the semiconductor chip, it can be of advantage when the direction w runs along a diagonal of the semiconductor chip.

The z position of the writing head 4 (and therefore also the z height of the writing nozzle 5) is controlled by a known position measuring and control circuit that enables control of the z position of the writing head 4 with an accuracy lying in the micrometer range that suffices for the application of adhesive to the substrate 2. In order that the z height of the tip of the writing nozzle 5 secured to the writing head 4 can be adjusted relative to the surface of the substrate 2, the relationship still has to be determined between the z position of the writing head 4 and the reference height H_{R}, i.e. that z position Z_{R} of the writing head 4 has to be determined at which the tip of the writing nozzle 5 is located on the reference height H_{R}.

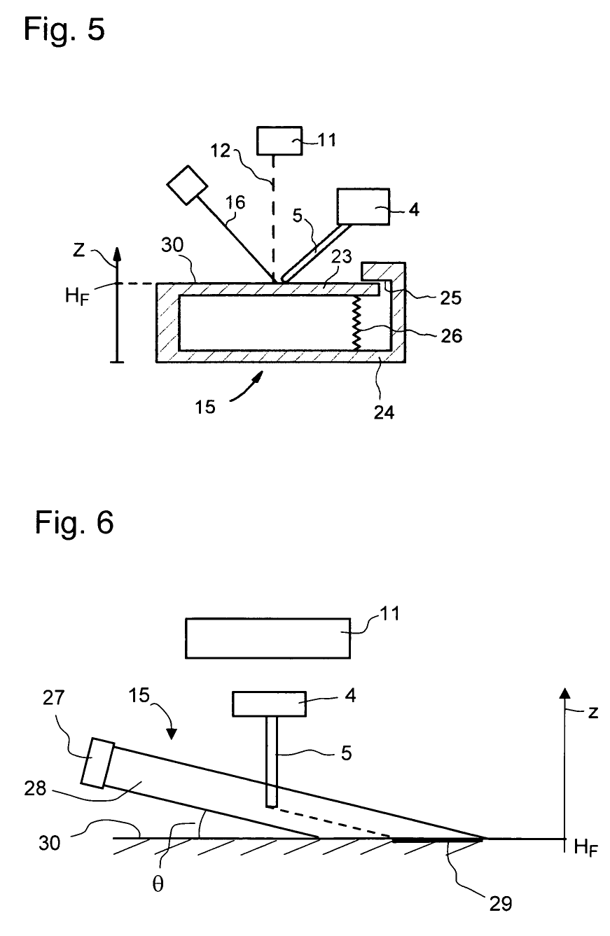

This determination can be carried out in different ways. In a first embodiment the laser 14, the camera 11 and a calibration device 15 with a reference surface 30 that deflects when the writing nozzle 5 touches it are used. The surface of a deflecting bar 23 for example can serve as the deflectable reference surface 30 as is described in more detail based on FIG. 5. The calibration device 15 contains a base 24 with a stop 25, the deflecting bar 23 and a spring 26. One end of the deflecting bar 23 bears on the base 24. The spring 26 presses the other end of the deflecting bar 23 against the stop 25 of the base 24. The z height H_{F} of the reference surface 30 is defined by this position of the deflecting bar 23. The position of the point of impingement P of the laser beam 16 on the deflecting bar 23 is measured by means of the camera 11 and from it the z height HF calculated analogously to equation (3):
H_{F}=H_{R}+k*Δp*tan(ψ) (4)
Here Δp denotes the distance in pixel coordinates of the camera 11 between the position of the point of impingement P of the laser beam 16 when the point of impingement P is on the reference height H_{R} and the position of the point of impingement P of the laser beam 16 on the reference surface 30 along the projection of the laser beam 16 onto the xy plane.

Afterwards the writing head 4 is lowered in z direction. As soon as the tip of the writing nozzle 5 touches the deflecting bar 23 and deflects it against the force of the spring 26, the position of the point of impingement P on the deflecting bar 23 shifts. The z height z_{S} of the writing head 4 is now determined at that time at which the camera 11 detected the start of the shifting of the position of the point of impingement P. The z height z_{S} is equal to the height H_{F}: z_{S}=H_{F}.

FIG. 6 illustrates a second embodiment with which the calibration device 15 shown schematically and from the side comprises a light source 27 that illuminates the writing nozzle 5 with a light beam 28 from the side and obliquely under the angle θ so that the shadow 29 of the writing nozzle 5 falls on the reference surface 30 of the calibration device 15. The height H_{F} of the reference surface 30 determined as with the previous embodiment from the measured position of the point of impingement of the laser beam on the reference surface 30. During lowering of the writing head 4 the shadow 29 approaches the writing nozzle 5. As soon as the writing nozzle 5 touches the reference surface 30 an end of the shadow 29 and the tip of the writing nozzle 5 coincide. The movement of the shadow 29 is monitored by the camera 11 and from it and the position data of the position measuring and control circuit the z position z_{S} of the writing head 4 is determined at which the writing nozzle 5 touches or would touch the reference surface 30. If the angle θ is known under which the light beam 28 emitted from the light source 27 falls on the reference surface 30 then from the movement of the shadow 29 and the position data of the position measuring and control circuit the z position z_{S} of the writing head 4 can be determined touchless namely without that the writing head 4 is lowered until the writing nozzle 5 in fact touches the reference surface 30.

During production, the application of adhesive takes place in accordance with the following steps:

Determining the height H₁ of the chip mounting surface of the substrate 2 to which the adhesive is to be applied,

Approaching the position z=H₁+Δz₀ with the writing head 4 whereby Δz₀ corresponds to the distance that the tip of the writing nozzle 5 should take up from the surface of the substrate 2, and

Moving the writing head 4 along the predetermined path for applying the adhesive.

When the chip mounting surface to which the adhesive is to be applied exceeds a certain size then it is of advantage to determine the height of the surface at least at three locations and to calculate therefrom the height H₁(x, y) as a function of the two coordinate axis x and y. During the movement along the path the z position of the writing head 4 is then controlled according to its actual position (x, y) to
z(x, y)=H₁(x, y)+Δz₀.

When the writing head 4 is moved in x direction and in y direction then, generally, the distance of the writing head 4 from the process support changes as a purely mechanical planarity of the guides 18 and 20 to the process area can only be achieved with great effort. For this reason, in a calibration process, the deviation Δz(x, y) of the z height of the writing head 4 is determined as a function of the location (x, y). When the laser 14 is secured to the second shuttle 21 of the drive system for the writing head 4 so that the laser 14 only follows the movements of the writing head 4 in x and y direction but not in z direction, then the function Δz(x, y) can be determined for example with the laser 14. The deviation Δz(x, y) is then used in production as a correction function in order to eliminate deviations caused by the system in that the writing head is guided on the z position z(x, y)=H₁+Δz(x, y)+Δz₀ or z(x, y)=H₁(x, y)+Δz(x, y)+Δz₀.

The apparatus in accordance with the invention for applying adhesive to a substrate is not limited to the field of the assembly of semiconductor chips. With the same apparatus, substrates for other components, for example optical components, passive electrical components such as resistors and capacitors, etc, can also be coated with adhesive.

While embodiments and applications of this invention have been shown and described, it would be apparent to those skilled in the art having the benefit of this disclosure that many more modifications than mentioned above are possible without departing from the inventive concepts herein. The invention, therefore, is not to be restricted except in the spirit of the appended claims and their equivalents.

What is claimed is:

1. An apparatus for applying adhesive to a substrate (2), the apparatus comprising
a writing head (4) comprising a writing nozzle (5);
a position measuring and control circuit (6) for controlling a position of the writing head (4) along a direction designated as z height;
a camera (11);
a laser (14), the laser beam and the camera (11) forming a triangulation measuring system for determining a z height of a substrate (2) in relation to a reference height; and
means for determining that z position of the writing head (4) at which the writing nozzle (5) touches the reference height.

2. The apparatus according to claim 1, characterized in that said means comprise a reference surface (30) deflectable in z direction.

3. The apparatus according to claim 1, characterized in that said means comprise a reference surface (30) and a light source (27) that illuminates the writing nozzle (5) so that a shadow (29) of the writing nozzle (5) falls on the reference surface (30).

4. A Method for applying adhesive to a substrate (2) by means of a writing nozzle (5) secured to a writing head (4), wherein a z position of the writing head (4) along a direction designated as z height is controlled by means of a position measuring and control circuit (6) and wherein the writing head (4) is moved along a path in a plane spanned by coordinates x and y, the method comprising:
a calibration process for determining the z position of the writing head (4) in relation to a reference height comprising the steps of:
determining a z height of a reference surface (30) in relation to the reference height by means of a triangulation measuring system, and
determining that z height of the writing head (4) at which the writing nozzle (5) touches the reference surface, and
the method further comprising applying adhesive to a substrate (2) by determining a z height H₁(x, y) of the substrate (2) in relation to the reference height by means of the triangulation measuring system, and
controlling the z position of the writing head (4) during the application of the adhesive according to the actual position (x, y) of the writing head (4) to a value z(x, y)=H₁(x, y)+Δz₀, whereby the quantity Δz₀ designates a predetermined value.

5. The method according to claim 4, characterized in that the z position of the writing head (4) during the application of the adhesive is controlled to a value z(x, y)+Δz(x, y, {u}) wherein the function Δz(x, y, {u}) is a correction function and wherein {u} is either equal to {0} or designates additional coordinates that characterize the position of the writing head (4).

6. The method according to claim 4, characterized in that the z height H₁(x, y) of the substrate (2) is approximated by a constant value H₁.

7. The method according to claim 5, characterized in that the z height H₁(x, y) of the substrate (2) is approximated by a constant value H₁.
